(19) United States
(12) Patent Application Publication
(10) Pub. No.: US 2018/0370823 A1
(43) Pub. Date: Dec. 27, 2018

(54) METHOD FOR RECOVERING OIL AND VISCOSIFYING POLYMERS IN POLYMER-FLOOD PRODUCED WATER

(71) Applicant: SUEZ GROUPE, Paris La Defense Cedex (FR)

(72) Inventor: Emilie SUTTON-SHARP, Paris (FR)

(21) Appl. No.: 16/063,626

(22) PCT Filed: Dec. 15, 2016
(86) PCT No.: PCT/EP2016/081124

§ 371 Date: Jun. 18, 2018

(30) Foreign Application Priority Data
Dec. 18, 2015 (EP) 15201371.0

(51) Int. Cl. C02F 1/44; C02F 1/40; B01D 17/04; B01D 61/24; E21B 43/40; C09K 8/588

(52) U.S. Cl. CPC C02F 1/444; C02F 1/40; B01D 17/045; C02F 2101/325; E21B 43/40; C09K 8/588; B01D 61/246

(57) ABSTRACT

The present invention concerns a method for recovering pure oil stream and viscosifying polymers in polymer-flood produced water issued from an oil and gas field using a membrane coalescing contactor.

The present invention concerns a method for recovering oil and viscosifying polymers in produced water issued from an oil and gas field.

The exploration and production of oil and gas generates a large quantity of water. The world average is 3 barrels of water for each barrel of oil produced and this ratio increases over the lifetime of the producing wells. In mature oil fields where the reservoir pressure has reduced to the point that oil cannot be produced from the reservoir naturally, the oil needs to be removed by injecting a substance into the reservoir to displace oil towards a producing well and maintain reservoir pressure.

Water is used as an injection fluid because it is immiscible with oil and will displace it, allowing more oil to be recovered from the reservoir. Produced water is produced as a byproduct along with the Oil and Gas. Produced water is an oil/water/solid mixture.

This process is known as Enhanced Oil Recovery (EOR) and more specifically as:
water flooding EOR if only water is injected into the oil bearing formation,
chemical EOR when water and chemicals are injected,
low salinity EOR when low salinity water is injected and
steam EOR when water is injected as steam.

The water source for the enhanced oil recovery process can be aquifer water, surface water, seawater or recycled produced water.

In some chemical EOR technique, a high-molecular-weight and viscosity-enhancing polymer, such as partially hydrolysed polyacrilamide (HPAM), can be added to the waterflood for decreasing the mobility of the flood and, as a consequence, improving the sweep efficiency of the waterflood and resulting in improved oil recovery and the generation of polymer-flood produced water (PFPW) at the producing well.

Oil & Gas companies are increasingly looking at reusing produced water for reinjection in the oil bearing formation to reduce their environmental footprint and their water management costs. This option requires a comprehensive treatment process to avoid plugging the reservoir and the injection equipment with the undesired compounds contained in the produced water such as suspended solids, oil and scale forming dissolved solids.

In addition to the complicated chemistry of produced water, the polymer used for sweeping oil toward production wells is resulting in the generation of polymer-flood produced water (PFPW) with a high viscosity, since most of the polymer remains in the produced water. The produced water from the polymer flooding is therefore more difficult to treat than from conventional Oil&Gas well operations.

Because of its high viscosity, conventional produced water treatment methods, such as flotation, gravity separation or liquid/liquid hydrocyclones are not effective.

Recently developed polymer-flood produced water treatment techniques teach mostly breaking the polymer chain to reduce produced water viscosity.

United State Patent Application US 2012/0108473 is directed to a process for treatment of produced water obtained from an enhanced oil recovery process using polymers, wherein an oxidizing agent is injected into produced water in a quantity such that the viscosity of said water is reduced to a value below 2 cps in a short period of less than 5 hours from the injection of the oxidizing agent, and a reducing agent is then injected in the necessary quantity to neutralize all the resulting excess oxidizing agent.

This method has the following disadvantages:
oxidizing the polymer rather than keeping it in the water phase for reuse induces a chemical loss for the oilfield service company,
to overcome interference with the numerous contaminants naturally present in produced water, the oxidizing agent needs to be significantly overdosed to break-up the viscosifying polymer which induces high oxidizing agent consumption costs,
after oxidation, the oil can not be recovered from the produced water which induces a revenue loss for the Oil & Gas operator.

Therefore, there is a need for a more economic and efficient process for treating polymer-flood produced water and recovering oil and viscosifying polymers.

The present invention relates to a method for recovering pure oil stream and viscosifying polymers in polymer-flood produced water issued from an oil and gas field.

The method of the invention comprises:
a first step of directing the produced water to a membrane coalescing contactor,
a second step of recovering:
   the pure oil stream from the membrane of said membrane coalescing contactor and;
   deoiled viscosified water containing residuals of viscosifying polymers remaining outside the membrane.

The term “produced water” means water produced as a byproduct along with crude oil or gas exploration and production, especially water brought to the surface in an oil or gas recovery process.

The physical and chemical properties of produced water vary considerably depending on the geographic location of the field, the geological formation from which it comes, and the type of hydrocarbon product being produced. The major constituents in produced water are suspended solids, dissolved solids, such as carbonate/bicarbonate, sulfate, silica and scale forming divalent ions, and organic compounds, such as aliphatic hydrocarbons and aromatic hydrocarbons.

The method of the invention can especially be applied for treating a viscosified produced water.

The term “viscosified produced water” means produced water containing back produced polymer and obtained as byproduct after polymer flooding enhanced recovery process.

The method of the invention allows the separation of oil with other contents of produced water by coalescence and enables the recovery of a deoiled water stream containing viscosifying polymers but free of oil.

Coalescence of oil/water emulsion is a process whereby two or more oil droplets become joined together forming larger droplets with the ultimate separation of the emulsion into two phases (oil and water).

Coalescence process is used for separating oil from water. Since the polymers used in polymer-flood enhanced oil recovery are water-soluble, they remain in the water phase and are also separated from oil after the first step of directing the produced water to a membrane coalescing contactor, named as coalescing step.

The term “membrane coalescing contactor” is referred to a device containing non-dispersive hydrophobic hollow fiber or tubular membranes which are able to coalesce oil from polymer-flood produced water on the first surface of membrane and collect a stream of coalesced oil from the second surface of membrane.

Said membrane comprises microporous hollow fiber membranes, selected from polyethylene, polypropylene, polyolefins, polyvinyl chloride (PVC), amorphous Polyethylene terephthalate (PET), polyolefin copolymers, poly(etheretherketone) type polymers, surface modified polymers, mixtures or combinations thereof. The surface modified polymers comprise polymers modified chemically at one or more halogen groups or by corona discharge or ion embedding techniques.

In a conventional coalescence contactor containing a serial of plates made of polymer, oil droplet is coalesced on the surface of plates but cannot pass through the plates. On the contrary, in the membrane coalescing contactor used in the present invention, oil droplets are coalesced on the first surface of hollow fiber membrane and can pass through the membrane and be collected on the other surface of membrane. Consequently, compared to a conventional coalescence contactor containing a serial of plates made of polymer, a membrane coalescing contactor exhibits a higher packing density of the coalescing media since the available surface for coalescence is higher and a better oil-water separation due to the microporous nature of the membrane. Indeed, a membrane coalescing contactor provides a physical barrier that water cannot cross, especially when the membrane is porous. Thus, the oil recovered through membrane coalescing contactor is pure oil. Whereas when using coalescing plates for coalescence, oil droplets still contain an amount of water and the oil recovered is not pure oil because of the absence of physical barrier.

The use of a coalescing contactor instead of conventional membrane hydrophilic devices allows to recover pure oil from the process. Thus, the method of the invention combines the advantages of recovering pure oil and recovering reusable viscosified water.

In a preferred embodiment, the membrane coalescing contactor used in the present invention is the device described in WO 2013/188837.

It is to be noted that the present invention does not exclude the embodiments wherein there is at least one supplementary step between the first step and the second step.

In an embodiment, the second step of recovering is carried out by out-in crossflow.

The term “out-in crossflow” means that the feed flood passes tangentially along the surface of the membrane to avoid particles contained in the polymer flood produced water to plug the contactor.

The method of the invention can be used for recovering viscosifying polymers selected from a polyacrylamide, such as partially hydrolysed polyacrylamide, or biopolymer such as xanthan gum or guar gum.

In an embodiment, the method of invention comprises a polishing step after the second step.

Said polishing step can be any conventional polishing step for removing a specific content in produced water obtained after the second step, such as polymers, dissolved solids and/or water soluble oil. For example, oxidation process can be used for destroying viscosifying polymers and water soluble oil, filtration can be used for removing the viscosifying polymers. Dissolved solids can be removed by Reverse Osmosis.

In another embodiment, the method of invention comprises successively several polishing steps after the second step for removing different kinds of contents in produced water.

The deoiled viscosified water recovered from the step of method of invention may be reinjected in a hydrocarbon bearing formation. Since the method of the invention does not destroy polymer comprised into water, it is possible to reuse the deoiled viscosified water for reinjection as part of a chemical EOR process, thus allowing oil companies to reduce their environmental footprint and their water management costs.

The deoiled viscosified water recovered from polishing step may be reinjected in a hydrocarbon bearing formation or discharged to a surface water body.

A hydrocarbon bearing formation can be an oil and/or gas bearing formation.

In a preferred embodiment, the method of invention is used for recovering the residual of viscosifying polymer, particularly the residual of partially hydrolysed polyacrylamide in polymer-flood enhanced oil recovery.

The present invention concerns also a system for carrying out an above described method for recovering pure oil stream and viscosifying polymers in polymer-flood produced water issued from an oil and gas field.

The system of invention comprises a membrane coalescing contactor and optionally the devices for carrying out one or several polishing steps.

The system of invention may be used for treating produced water from chemical enhanced oil recovery using polymers.

Preferred embodiments of the invention are disclosed in following description and the accompanying drawing which are merely illustrative of such invention.

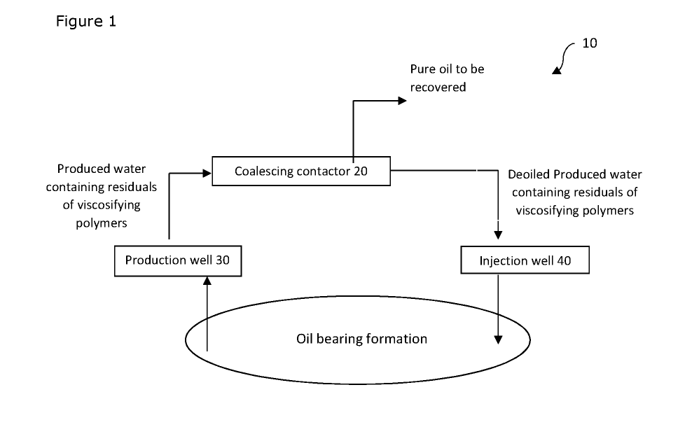

FIG. 1 is schematic illustration of the process of the present invention.

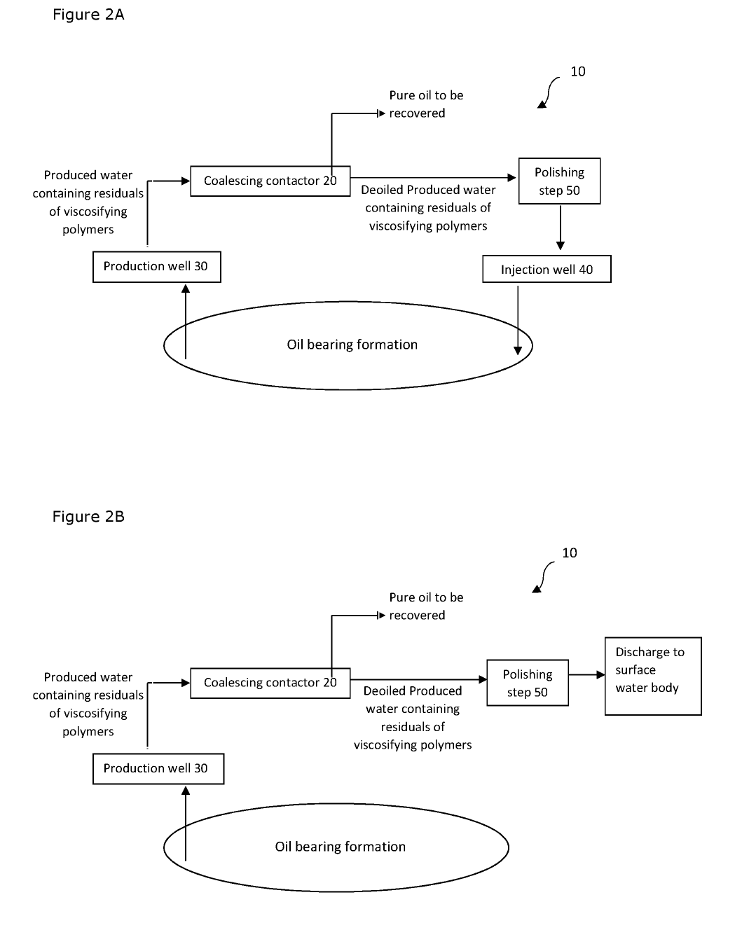

FIGS. 2A and 2B are schematic illustration of the process of the present invention including polishing step.

In FIG. 1, the produced water treatment system of the present invention is indicated generally by the numeral 10. The system comprises a coalescing contactor 20. According to the first step of the method of invention, produced water stream containing residuals of viscosifying polymer is directed into coalescing contactor 20. Said produced water stream is generated in oil and gas production well 30 by polymer-flood enhanced oil recovery. According to the second step of the method of invention, deoiled produced water containing residuals of viscosifying polymers issued from coalescing contactor 20 is reinjected in an oil bearing formation via injection well 40. Pure oil recovered from coalescing contactor 20 in the second step is collected.

In FIGS. 2A and 2B, the produced water treatment system 10 includes a membrane coalescing contactor 20. According to the first step of the method of invention, produced water stream containing residuals of viscosifying polymer is directed into the membrane coalescing contactor 20. Said produced water stream is generated in oil and gas production well 30 by polymer-flood enhanced oil recovery. According to the second step of the method of invention, deoiled produced water issued from coalescing contactor 20 is directed to polishing step 50 then reinjected in an oil bearing formation via injection well 40 (FIG. 2A) or discharged to surface water body (FIG. 2B). Pure oil recovered from coalescing contactor 20 in the second step is collected.

1. A method for recovering pure oil stream and viscosifying polymers in polymer-flood produced water issued from an oil and gas field, comprising:
a first step of directing the polymer-flood produced water to a membrane coalescing contactor (20),
a second step of recovering:
the pure oil stream from the membrane of said membrane coalescing contactor; and
deoiled viscosified water containing residuals of viscosifying polymers remaining outside the membrane.

2. The method according to claim 1, wherein the second step of recovering is carried out by out-in crossflow coalescence.

3. The method according to claim 1, wherein said method comprises a polishing step (50) after the second step.

4. The method according to claim 1, wherein deoiled viscosified water recovered from the second step of this method is reinjected in a hydrocarbon bearing formation (40).

5. The method according to claim 1, wherein deoiled viscosified water recovered from the polishing step is reinjected in a hydrocarbon bearing formation (40) or discharged to a surface water body.

6. The method according to claim 1, wherein the residuals of viscosifying polymer are partially hydrolysed polyacrylamide.

7. A system (10) for carrying out a method for recovering pure oil stream and viscosifying polymers in polymer-flood produced water issued from an oil and gas field according to claim 1, said system comprising a membrane coalescing contactor.

8. The system according to claim 7, said system comprising devices for carrying out a polishing step.

9. The method of claim 1, for treating produced water from chemical enhanced oil recovery using polymer, performed using a system comprising a membrane coalescing contactor.

10. The method of claim 9, further comprising a polishing step using polishing device said system.

11. The method according to claim 2, wherein said method comprises a polishing step (50) after the second step.

12. The method according to claim 2, wherein deoiled viscosified water recovered from the second step of this method is reinjected in a hydrocarbon bearing formation (40).

13. The method according to claim 3, wherein deoiled viscosified water recovered from the second step of this method is reinjected in a hydrocarbon bearing formation (40).

14. The method according to claim 2, wherein deoiled viscosified water recovered from the polishing step is reinjected in a hydrocarbon bearing formation (40) or discharged to a surface water body.

15. The method according to claim 3, wherein deoiled viscosified water recovered from the polishing step is reinjected in a hydrocarbon bearing formation (40) or discharged to a surface water body.

16. The method according to claim 2, wherein the residuals of viscosifying polymer are partially hydrolysed polyacrylamide.

17. The method according to claim 3, wherein the residuals of viscosifying polymer are partially hydrolysed polyacrylamide.

18. The method according to claim 4, wherein the residuals of viscosifying polymer are partially hydrolysed polyacrylamide.

19. The method according to claim 5, wherein the residuals of viscosifying polymer are partially hydrolysed polyacrylamide.

20. The method of claim 7, performed using a system comprising a membrane coalescing contactor.
